(19) United States
(12) Patent Application Publication
(10) Pub. No.: US 2015/0323755 A1
(43) Pub. Date: Nov. 12, 2015

(54) CAMERA MODULE

(71) Applicant: SAMSUNG ELECTRO-MECHANICS CO., LTD., Suwon-Si (KR)

(72) Inventor: Young Mu Kwon, Suwon-Si (KR)

(73) Assignee: SAMSUNG ELECTRO-MECHANICS CO., LTD., Suwon-Si (KR)

(21) Appl. No.: 14/335,843

(22) Filed: Jul. 18, 2014

(30) Foreign Application Priority Data
May 12, 2014 (KR) 10-2014-0056600

(51) Int. Cl. G02B 7/00; G03B 3/00; G03B 17/12; G02B 7/02; G02B 7/04

(52) U.S. Cl. CPC G02B 7/003; G02B 7/02; G02B 7/04; G03B 17/12; G03B 3/00

(57) ABSTRACT

In a camera module according to an exemplary embodiment of the present disclosure, a frame including a lens barrel may be accommodated in a housing in a state of being elastically supported by elastic members, and a tilt of the frame with respect to the housing may be adjusted by tilt adjusting units.

### CROSS-REFERENCE TO RELATED APPLICATION

This application claims the benefit of Korean Patent Application No. 10-2014-0056600 filed on May 12, 2014, with the Korean Intellectual Property Office, the disclosure of which is incorporated herein by reference.

### BACKGROUND

The present disclosure relates to a camera module.

A camera module, included in a portable electronic device, may include a lens barrel, supporting a lens, driven to be moved in an optical axis direction in order to perform auto-focusing.

Here, the lens barrel should be moved in parallel with an optical axis of the lens, which should be disposed perpendicularly with respect to an image forming surface of an image sensor.

However, the lens barrel may be tilted, such that the optical axis of the lens may not be disposed perpendicularly with respect to the image forming surface of the image sensor in an assembly process, due to tolerance formed in a manufacturing process of the camera module, or the like.

### SUMMARY

An exemplary embodiment in the present disclosure may provide a camera module capable of correcting a tilted state of an optical axis of a lens with respect to an image forming surface of an image sensor.

In a camera module according to an exemplary embodiment of the present disclosure, a frame including a lens barrel may be accommodated in a housing in a state of being elastically supported by elastic members, and a tilt of the frame with respect to the housing may be adjusted by tilt adjusting units.

In the camera module according to an exemplary embodiment of the present disclosure, the tilt of the frame with respect to the housing may be adjusted, such that an optical axis of a lens provided in the lens barrel may be positioned perpendicularly with respect to an image forming surface of an image sensor.

The frame of the camera module according to an exemplary embodiment of the present disclosure may be elastically supported by the elastic members so as to be disposed to be spaced apart from the housing in an optical axis direction, and a gap between the frame and the housing may be adjusted by the tilt adjusting units.

One ends of the tilt adjusting units of the camera module according to an exemplary embodiment of the present disclosure may be supported by the frame, and the other ends thereof may be screw-coupled to the housing, such that the tilt of the frame with respect to the housing may be adjusted.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is an exploded perspective view of a camera module according to an exemplary embodiment of the present disclosure;

FIG. 2 is a cross-sectional view of the camera module according to an exemplary embodiment of the present disclosure;

FIG. 3A is a partially exploded perspective view of the camera module according to an exemplary embodiment of the present disclosure;

FIG. 3B is a plan view of a housing according to an exemplary embodiment of the present disclosure;

FIG. 4A is a schematic cross-sectional view illustrating a case in which assembly is performed in a state in which an optical axis of a lens is tilted in the camera module; and

FIG. 4B is a schematic cross-sectional view illustrating a manner in which the optical axis of the lens in the camera module, when tilted, is adjusted, according to an exemplary embodiment of the present disclosure.

### DETAILED DESCRIPTION

Hereinafter, exemplary embodiments of the present disclosure will be described in detail with reference to the accompanying drawings.

The disclosure may, however, be exemplified in many different forms and should not be construed as being limited to the specific embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

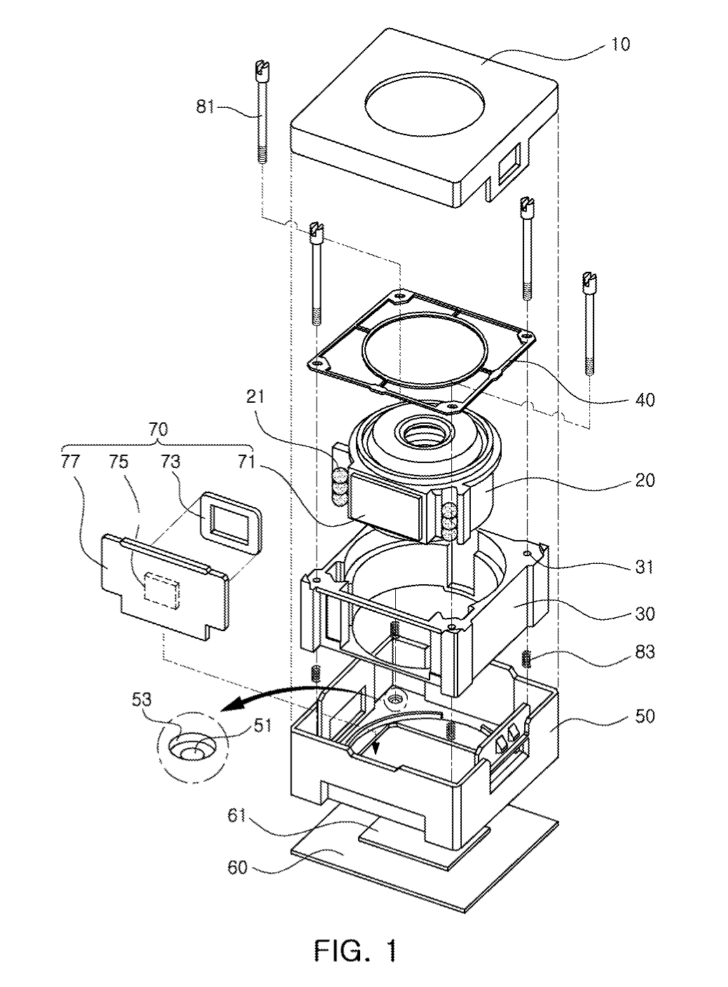

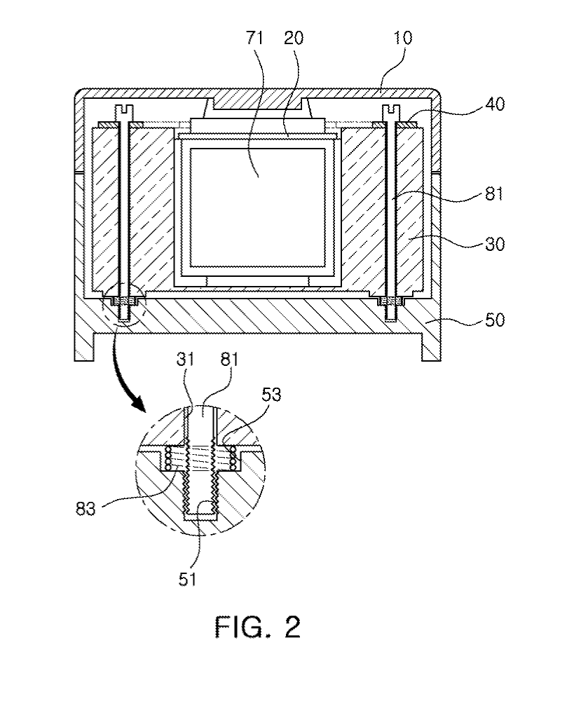

FIG. 1 is an exploded perspective view of a camera module according to an exemplary embodiment of the present disclosure; while FIG. 2 is a cross-sectional view of the camera module according to an exemplary embodiment of the present disclosure.

Referring to FIGS. 1 and 2, a camera module according to an exemplary embodiment of the present disclosure may include a lens barrel 20, a frame 30, and a housing 50.

Terms with respect to directions to be used hereinafter will now be defined. An optical axis direction refers to a vertical direction, based on the lens barrel 20, as illustrated in FIG. 1.

The lens barrel 20 may have a hollow cylindrical shape so that at least one lens for imaging a subject may be accommodated therein, and the at least one lens may be provided in the lens barrel 20 along an optical axis.

The lens barrel 20 may be coupled to the frame 30. In detail, the lens barrel 20 may be disposed in the frame 30.

The lens barrel 20 may be moved in the optical axis direction within the frame 30 in order to perform auto-focusing.

In order to move the lens barrel 20 in the optical axis direction, a magnet 71, a portion of a driving part 70, may be mounted on a surface of the lens barrel 20, and a coil 73 may be disposed in the housing 50 so as to face the magnet 71.

The coil 73 may be mounted on a first substrate 77 and may be disposed to face the magnet 71, while the first substrate 77 may be fixed to the housing 50.

The coil 73 may interact with the magnet 71 electromagnetically in order to move the lens barrel 20 in the optical axis direction.

In addition, a yoke may be attached to the coil 73 to prevent leakage of a magnetic flux.

The magnet 71 may form a magnetic field having a predetermined magnitude. When power is applied to the coil 73, driving force may be generated by the electromagnetic interaction between the magnet 71 and the coil 73 to move the lens barrel 20 in the optical axis direction.

A hall sensor 75 may be mounted on the first substrate 77 so as to face the magnet 71 and may sense a position of the magnet 71. Even though the hall sensor 75 is disposed inside of the coil 73 in an exemplary embodiment of the present disclosure, it may also be disposed outside of the coil 73.

The frame 30, provided to support the lens barrel 20 to be driven in the optical axis direction, may accommodate the lens barrel 20 therein.

Accordingly, the frame 30 may have an internal space formed therein so as to accommodate the lens barrel 20 therein.

Meanwhile, as a guide unit guiding the driving of the lens barrel 20, when the lens barrel 20 is moved in the optical axis direction within the frame 30, a plurality of ball bearings 21 may be provided in the optical axis direction within the lens barrel 20.

The plurality of ball bearings 21 may contact an outer surface of the lens barrel 20 and an internal surface of the frame 30 to guide the movement of the lens barrel 20 in the optical axis direction.

That is, the plurality of ball bearings 21 may be disposed between the lens barrel 20 and the frame 30 and may roll to support the movement of the lens barrel 20 in the optical axis direction.

Accordingly, when the lens barrel 20 is driven in the optical axis direction, the plurality of ball bearings 21 may support the lens barrel 20, such that the lens barrel 20 may be moved in parallel with the optical axis.

Meanwhile, a stopper 40 may be disposed above the frame 30 to limit a movement distance of the lens barrel 20 in the optical axis direction.

The housing 50 may be coupled to the case 10 to form an outer casing of the camera module according to an exemplary embodiment of the present disclosure.

A second substrate 60 on which an image sensor 61 is mounted, may be fixedly disposed below the housing 50.

Meanwhile, the frame 30 may be disposed in an internal space of the housing 50 and be disposed to be spaced apart from the housing 50 in the optical axis direction.

To this end, the camera module according to an exemplary embodiment of the present disclosure may include elastic members 83 disposed between the frame 30 and the housing 50.

The frame 30 may be elastically supported by the elastic members 83 in a state of being spaced apart from the housing 50 in the optical axis direction.

Here, the frame 30 may be elastically supported in a state of being relatively aligned with the housing 50.

When the frame 30 is accommodated in the internal space of the housing 50, the frame 30 may be attached to the housing 50 in a state of being tilted with respect to the housing 50 due to assembly tolerance between the frame 30 and the housing 50, or the like. As a result, tilting of the optical axis of the lens provided in the lens barrel 20 accommodated in the frame 30 may be problematic.

In addition, even in the case that the frame 30 is not tilted with respect to the housing 50, the optical axis of the lens provided in the lens barrel 20 may also be tilted due to assembly tolerance between the frame 30 and the lens barrel 20.

However, in the camera module according to an exemplary embodiment of the present disclosure, since the frame 30 may be relatively aligned with the housing 50 in a state of being elastically supported by the elastic members 83, an assembly defect due assembly tolerance between members may be significantly decreased.

For example, in the camera module according to an exemplary embodiment of the present disclosure, in the case in which the optical axis of the lens provided in the lens barrel 20 is disposed to be tilted with respect to an image forming surface of the image sensor 61 (that is, in a state in which the optical axis of the lens is tilted), pressure may be applied to a portion of the frame 30 to adjust the tilted state of the optical axis of the lens.

In other words, tilting of the frame 30 with respect to the housing 50 may be adjusted to adjust a tilt of the lens barrel 20 accommodated in the frame 30. As a result, the tilted state of the optical axis of the lens provided in the lens barrel 20 may be adjusted.

Accordingly, the optical axis of the lens may be positioned perpendicularly with respect to the image forming surface of the image sensor 61.

Here, the term ‘perpendicularly’ may include the case in which an angle between a virtual vertical line, perpendicular to the image forming surface of the image sensor 61, and the optical axis of the lens, is within a preset range, as well as the case in which an angle between the image forming surface of the image sensor 61 and the optical axis of the lens is 90 degrees.

For example, the optical axis of the lens is not necessarily disposed at an angle of 90 degrees with respect to the image forming surface of the image sensor 61, and it may be sufficient that the tilted state of the optical axis of the lens be adjusted so that an image of a subject may be clearly captured.

Accordingly, a phenomenon in which assembly is performed in a state in which the optical axis of the lens is tilted with respect to the image forming surface of the image sensor 61 due to various factors such as assembly tolerance, and the like, may be prevented. As a result, a phenomenon in which the optical axis of the lens is tilted may be prevented, thereby securing perpendicularity of the optical axis of the lens with respect to the image forming surface of the image sensor 61.

Meanwhile, the camera module according to an exemplary embodiment of the present disclosure may include tilt adjusting units 81 applying pressure to the frame 30 to adjust the tilted state of the optical axis of the lens.

The tilt adjusting units 81 may be coupled to the frame 30 and the housing 50 to adjust a gap between the frame 30 and the housing 50.

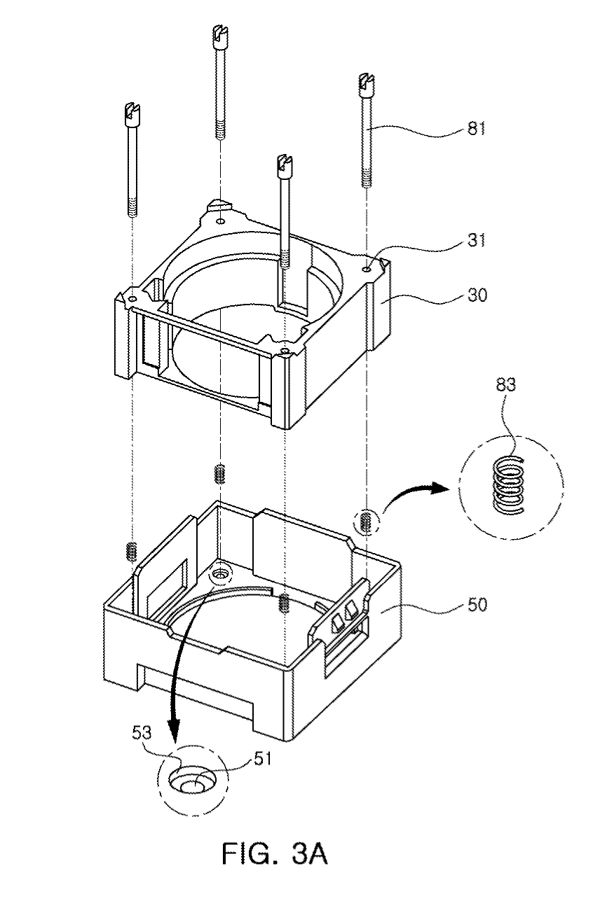

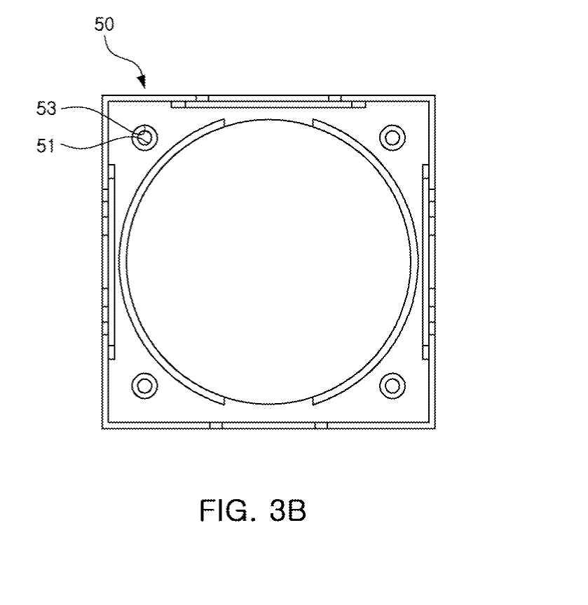

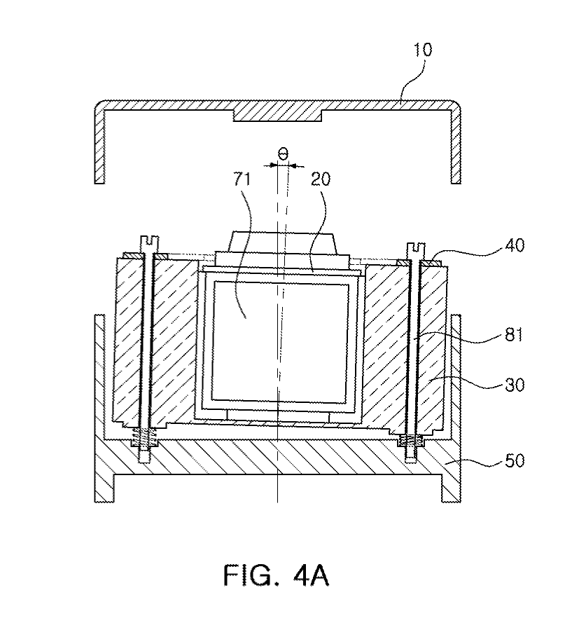

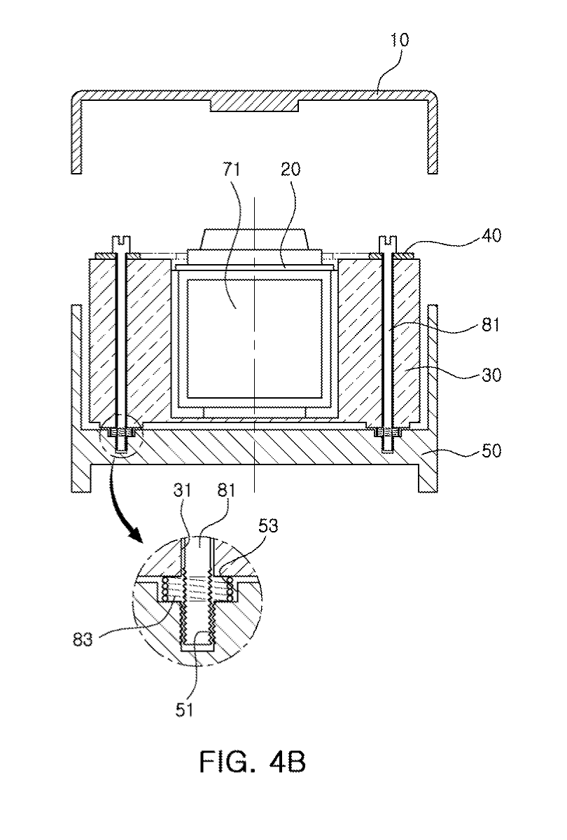

This will be described below in detail with reference to FIGS. 3A through 4B.

FIG. 3A is a partially exploded perspective view of the camera module according to an exemplary embodiment of the present disclosure; and FIG. 3B is a plan view of a housing according to an exemplary embodiment of the present disclosure.

In addition, FIG. 4A is a schematic cross-sectional view illustrating a case in which assembly is performed in a state in which an optical axis of a lens is tilted in the camera module; and FIG. 4B is a schematic cross-sectional view illustrating a manner in which the optical axis of the lens, when tilted, is adjusted, in the camera module according to an exemplary embodiment of the present disclosure.

Adjusting the tilted state of the optical axis of the lens in the camera module according to an exemplary embodiment of the present disclosure will be described with reference to FIGS. 3A through 4B.

First, referring to FIGS. 3A and 3B, through-holes 31 into which the tilt adjusting units 81 are inserted may be formed in the frame 30.

The through-holes 31 may be formed at corners of the frame 30, respectively, and the tilt adjusting units 81 may be inserted into the through-holes 31, such that one ends thereof are supported by an upper surface of the frame 30.

Adjusting grooves 51 into which the other ends of the tilt adjusting units 81 are inserted may be formed in the housing 50.

The adjusting grooves 51 may be formed in positions corresponding to those of the through-holes 31, and the other ends of the tilt adjusting units 81 may be coupled to the adjusting grooves 51.

That is, the tilt adjusting units 81 may be inserted into the through-holes 31 of the frame 30, such that the other ends thereof protrude outwardly of the frame 30 and are inserted into the adjusting grooves 51 of the housing 50 in a state in which one ends thereof are supported by the upper surface of the frame 30.

Here, the adjusting groove 51 may have a screw thread formed in an inner wall thereof, and the tilt adjusting unit 81 may also have a screw thread formed at the other end thereof, such that the other end of the tilt adjusting unit 81 and the adjusting groove 51 are screw-coupled to each other.

The elastic members 83 may be disposed between the frame 30 and the housing 50 and may support lower portions of each corner of the frame 30.

Seating grooves 53 in which the elastic members 83 are disposed may be formed in the housing 50. The seating grooves 53 may be formed at positions corresponding to those of the through-holes 31, and the adjusting grooves 51 may be formed in bottom surfaces of the seating grooves 53.

Accordingly, the elastic members 83 may be disposed in positions corresponding to those of the tilt adjusting units 81, and the other ends of the tilt adjusting units 81 may penetrate through the elastic members 83 and then be inserted into the seating grooves 53 and the adjusting grooves 51.

The frame 30 may be disposed to be spaced apart from the housing 50 in the optical axis direction in a state of being supported by the elastic members 83.

Accordingly, the gap between the frame 30 and the housing 50, as well as a tilt of the frame 30 with respect to the housing 50, may be adjusted by tightening or loosening the tilt adjusting units 81.

Referring to FIG. 4A, in the case in which the frame 30 is accommodated in the housing 50, the frame 30 may be attached to the housing 50 in a state of being tilted with respect to the housing 50 due to various factors such as a manufacturing tolerance, an assembly tolerance, or the like, of each component.

Since the frame 30 accommodates the lens barrel 20 therein, when the frame 30 is assembled in a state of being tilted, the lens barrel 20 may be tilted. As a result, the optical axis of the lens provided in the lens barrel 20 may be tilted.

For example, the optical axis of the lens is not disposed perpendicularly with respect to the image forming surface of the image sensor 61 disposed below the housing 50, but may be tilted at a predetermined angle (θ) with respect to a virtual vertical line perpendicular to the image forming surface of the image sensor 61.

In the case in which the optical axis of the lens is tilted as described above, an image captured by the camera module may be distorted to have a negative influence on resolution, for example, deteriorating image quality.

However, in the camera module according to an exemplary embodiment of the present disclosure, since the tilt of the frame 30 with respect to the housing 50 may be adjusted by the tilt adjusting units 81 as shown in FIG. 4B, the tilted state of the optical axis of the lens may be adjusted.

That is, the tilt of the frame 30 may be adjusted, thereby positioning the optical axis of the lens so as to be perpendicular with respect to the image forming surface of the image sensor 61.

Meanwhile, in the case in which the tilt adjusting units 81 are tightened, they may apply pressure to the frame 30. Therefore, the elastic members 83 elastically supporting the frame 30 may also be pressed, such that pressure is generated in the elastic members 83.

Here, in the case in which at least one of the tilt adjusting units 81, disposed at each corner of the frame 30 and the housing 50, is tightened in order to adjust the tilt of the frame 30 with respect to the housing 50, the pressure applied to the elastic members 83 may be changed.

Accordingly, a larger amount of force may be applied to one portion of the elastic member 83 as compared with the other portion thereof depending on a degree of the tilt of the frame 30 with respect to the housing 50.

The frame 30 may be fixed in a state of alignment, so that the optical axis of the lens is positioned perpendicularly with respect to the image forming surface of the image sensor 61.

After the tilted state of the optical axis of the lens is adjusted, the frame 30 may be fixed by an adhesive (not shown).

As set forth above, with the camera module according to exemplary embodiments of the present disclosure, the tilted state of the optical axis of the lens with respect to the image forming surface of the image sensor may be adjusted.

While exemplary embodiments have been shown and described above, it will be apparent to those skilled in the art that modifications and variations could be made without departing from the spirit and scope of the present disclosure as defined by the appended claims.

What is claimed is:

1. A camera module comprising:
a frame accommodating a lens barrel therein;
a housing accommodating the frame therein; and
elastic members disposed between the frame and the housing,
wherein the frame is elastically supported in a state of being relatively aligned with respect to the housing.

2. The camera module of claim 1, wherein the frame is supported by the elastic members, such that it is disposed to be spaced apart from the housing in an optical axis direction.

3. The camera module of claim 1, wherein an optical axis of a lens accommodated in the lens barrel is disposed perpendicularly with respect to an image forming surface of an image sensor disposed in the housing.

4. The camera module of claim 1, wherein the frame is fixed in a state of being aligned within the housing, so that an angle between a vertical line perpendicular to an image forming surface of an image sensor disposed in the housing and an optical axis of a lens provided in the lens barrel is within a preset range.

5. The camera module of claim 1, further comprising a stopper coupled to an upper portion of the frame and limiting a movement distance of the lens barrel in an optical axis direction.

6. The camera module of claim 1, further comprising tilt adjusting units coupled to the frame and the housing to adjust a gap between the frame and the housing.

7. The camera module of claim 6, wherein one ends of the tilt adjusting units are coupled to the frame and the other ends thereof are coupled to the housing.

8. The camera module of claim 7, wherein the other ends of the tilt adjusting units are screw-coupled to the housing.

9. The camera module of claim 6, wherein the frame is provided with through-holes penetrating therethrough in an optical axis direction, and the housing is provided with adjusting grooves in positions corresponding to those of the through-holes.

10. The camera module of claim 9, wherein the tilt adjusting units are inserted into the through-holes, such that one ends thereof are supported by the frame and the other ends thereof are coupled to the adjusting grooves.

11. A camera module comprising:
a frame supporting a lens barrel so that the lens barrel is driven in an optical axis direction;
a housing accommodating the frame therein;
elastic members disposed between the frame and the housing; and
tilt adjusting units coupled to the frame and the housing,
wherein a tilt of the frame with respect to the housing is adjusted by the tilt adjusting units in a state in which the frame is elastically supported by the elastic members.

12. A camera module comprising:
a frame accommodating a lens barrel therein;
a housing accommodating the frame therein;
elastic members elastically supporting the frame so that the frame is spaced apart from the housing in an optical axis direction;
tilt adjusting units applying pressure to the frame to generate pressure in the elastic members,
wherein the frame is fixed in a state of being relatively aligned with respect to the housing so that a larger amount of force is applied to one portion of the elastic members as compared with the other portion thereof.

13. The camera module of claim 12, wherein the housing is provided with seating grooves in which the elastic members are disposed and adjusting grooves formed in the seating grooves.

14. The camera module of claim 13, wherein the frame is provided with through-holes into which the tilt adjusting units are inserted.

15. The camera module of claim 14, wherein one ends of the tilt adjusting units are supported by the frame and the other ends thereof are screw-coupled to the adjusting grooves.

16. The camera module of claim 12, wherein the tilt adjusting units are coupled to each corner of the frame and the housing.

17. The camera module of claim 16, wherein the elastic members are disposed in positions corresponding to those of the tilt adjusting units.

18. The camera module of claim 12, further comprising a stopper coupled to an upper portion of the frame and limiting a movement distance of the lens barrel in the optical axis direction.
